(19) United States
(12) Patent Application Publication
(10) Pub. No.: US 2023/0166271 A1
(43) Pub. Date: Jun. 1, 2023

(54) VENTILATION DEVICE

(71) Applicant: Mahle International GmbH, Stuttgart (DE)

(72) Inventors: Daniel Eberle, Ludwigsburg (DE); Markus Michael, Ilsfeld (DE); Oliver Schultze, Stuttgart (DE)

(21) Appl. No.: 18/070,424

(22) Filed: Nov. 28, 2022

(30) Foreign Application Priority Data
Nov. 29, 2021 (DE) 102021213417.3

(51) Int. Cl. B03C 3/155; B03C 3/34; F24F 8/192

(52) U.S. Cl. CPC B03C 3/155; B03C 3/34; F24F 8/192

(57) ABSTRACT

A ventilation device may include a first air treatment device and an ionizer. The ionizer may include an electrode. A counter-electrode of the ionizer may be electrically conductively connected to the first air treatment device.

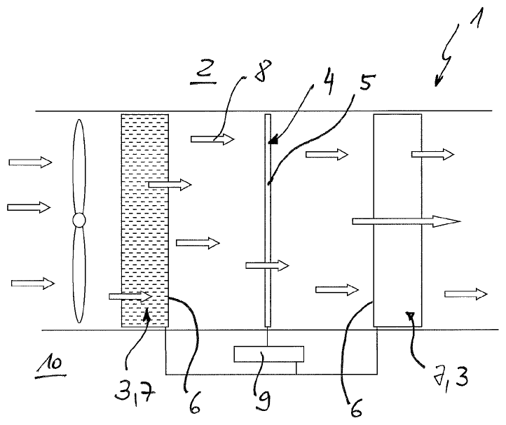

### CROSS-REFERENCE TO RELATED APPLICATIONS

This application claims priority to German Patent Application No. DE 10 2021 213 417.3, filed on Nov. 29, 2021, the contents of which is hereby incorporated by reference in its entirety.

### TECHNICAL FIELD

The present invention relates to a ventilation device, in particular for a motor vehicle, having a first air treatment device and an ionizer with an electrode. In addition, the invention relates to an air-conditioning system of a motor vehicle having such a ventilation device.

### BACKGROUND

In particular in motor vehicles, a multiplicity of filter systems for cleaning air are employed today, which comprise different filter elements, for example for filtering out fine dust, pollen, viruses, bacteria, etc. Even radiation sources, which emit ultraviolet light, can be employed in order to kill for example germs. Likewise, so-called ionizers can be employed with which the air to be cleaned is partially ionized. When this ionized air is blown for example into a passenger compartment, the radicals created in the process can promote chemical degradation processes, which can be utilised for neutralisation of odour and disinfection. Such ionizers usually work with high voltage, mostly of several thousand volts and an electric discharge on electrodes. The ionized air promotes a dust-binding effect since the charged ions settle on dust particles in the air and by their electrostatic interaction promote the formation of clusters. Such clusters, i.e. an agglomeration of dust particles, can then be more easily filtered out by filter elements because of the larger volume.

To date, such ionizers are formed as separate assemblies and installed for example upstream of a filter element in an air-conditioning system of a motor vehicle. It is disadvantageous, however, that such ionizers do not only require a considerable amount of installation space, but also an installation effort not to be underestimated.

### SUMMARY

The present invention therefore deals with the problem of stating for a ventilation device of the generic type an improved or at least an alternative embodiment, which in particular overcomes the disadvantages known from the prior art.

According to the invention, this problem is solved through the subject of the independent claim(s). Advantageous embodiments are the subject matter of the dependent claim(s).

The present invention is based on the general idea of no longer forming an ionizer employed to date in the region of an air-conditioning system or generally a ventilation device as a separate prefabricated assembly, but to integrate at least individual constituent parts of the ionizer in already existing components of the ventilation device and thus reduce not only an installation space requirement, but also an installation effort. The ventilation device according to the invention, which is employed for example in a motor vehicle, has a first air treatment device and an ionizer with an electrode. It is now substantial for the invention that a counter-electrode of the ionizer is electrically conductively connected to the first air treatment device. The counter-electrode of the ionizer is thus no longer part of the ionizer itself, but of the first air treatment device. Because of this, substantial advantages with respect to the installation space and the costs can be achieved. In addition, the efficiency can be increased. A further advantage of the ventilation device according to the invention consists in that with a same functionality a pressure loss can be reduced, in particular provided that the first air treatment device is a filter device. Existing components, such as for example the evaporator, are used as counter-electrode. Because of this, this counter-electrode need not be integrated, before or thereafter, for example in the ionizer, and thus not does not additionally increase the flow resistance by an additional electrode.

In an advantageous further development of the ventilation device according to the invention, the first air treatment device is formed as a filter device, for example as an electrically conductive activated charcoal filter, as an evaporator, as a heat exchanger, as a PTC heating element or as a fan. Even this non-conclusive listing gives an idea of the manifold embodiments that are possible for the first air treatment device. Essential here is merely a component of the air treatment device which can be utilised as counter-electrode of the ionizer and which is electrically conductively connected to a control unit for controlling the ionizer. Here, the housing components of the first air treatment device are obviously also conceivable as counter-electrode or as electrical connection to the counter-electrode, so that in the most favourable of cases components that are already present in such a filter device can be utilised as counter-electrode or as current conductor to the counter-electrode. Because of this, not only is the installation space requirement reduced but also a cabling expenditure.

In an advantageous further development of the solution according to the invention, a second air treatment device is provided, wherein the counter-electrode of the ionizer is additionally connected to the second air treatment device in an electrically conductive manner. In this case, the ionizer with its electrode is thus preferentially arranged between the two air treatment devices, wherein the latter each form a counter-electrode of the ionizer. Because of this, an electromagnetic field can be defined in two directions and thereby air-purification significantly improved. Obviously, it is also conceivable purely theoretically that the two air treatment devices are arranged in the flow direction parallel to one another, wherein in this case the ionizer with its electrode is arranged upstream of the two air treatment devices in order to ionize the air flowing there and promote a cluster formation, in particular of dust particles, which can subsequently be better separated in the air treatment devices arranged downstream of the ionizer than individual, significantly smaller dust particles. In an advantageous further development of the ventilation device according to the invention, the second air treatment device is formed as a filter device, for example as an electrically conductive activated charcoal filter.

Alternatively to this it is also conceivable that the second air treatment device is formed as a heat exchanger, as a PTC heating element or as a fan. This non-conclusive listing also gives an idea of the manifold possibilities that exist for forming the second air treatment device. Accordingly it is conceivable for example that the ionizer with its electrode is arranged downstream of a first air treatment device and upstream of a second air treatment device, wherein the two air treatment devices can be for example two filter devices or a filter device and an evaporator. Because of this, an improved gas separation and an improved anti-bacterial and anti-viral effect can be achieved in particular.

Further, the present invention is based on the general idea of equipping an air-conditioning system of a motor vehicle with a ventilation device described in the preceding paragraphs and thereby transfer the previously described advantages with respect to a reduced installation space requirement and reduced costs to such an air-conditioning system. Further important features and advantages of the invention are obtained from the subclaims, from the drawing and from the associated figure description by way of the drawing.

It is to be understood that the features mentioned above and still to be explained in the following cannot only be used in the respective combination stated, but also in other combinations or by themselves without leaving the scope of the present invention.

### BRIEF DESCRIPTION OF THE DRAWINGS

A preferred exemplary embodiment of the invention is shown in the drawing and is explained in more detail in the following description.

The FIGURE shows a ventilation device according to the invention.

### DETAILED DESCRIPTION

According to the FIGURE, a ventilation device 1 according to the invention, in particular for a motor vehicle 2, comprises a first air treatment device 3 and an ionizer 4 with an electrode 5. According to the invention, a counter-electrode 6 is now no longer part of the ionizer 4 itself, but electrically conductively connected to the first air treatment device 3 or a part of the same. In the embodiment of the ventilation device 1 according to the invention shown in the FIGURE, the first air treatment device 3 can be arranged upstream or downstream of the ionizer 4.

The first air treatment device 3 can be formed as a filter device, for example as an electrically conductive activated charcoal filter, as an evaporator, as a heat exchanger, as a PTC heating element or as a fan.

Likewise, a second air treatment device 7 can also be provided, wherein in this case the counter-electrode 6 cannot only be electrically conductively connected to the first air treatment device 3, but additionally also to the second air treatment device 7. By way of this, an electromagnetic field ionizing the air 8 flowing through the ventilation device 1 can be defined in two directions, namely from the ionizer 4 in the direction of the first air treatment device 3 and in the direction of the second air treatment device 7.

The second air treatment device 7 can be formed as a filter device, for example as electrically conductive activated charcoal filter, as an evaporator, as a heat exchanger or as a PTC heating element or fan. Purely theoretically it is even conceivable that a third air treatment device that is now shown is additionally connected to the counter-electrode 6 in an electrically conductive manner, so that between the ionizer 4 or its electrode 5 and the third air treatment device an electromagnetic field ionizing the air 8 can also be defined.

By ionizing the air 8, the dust-binding effect can also be significantly increased since the charged ions settle on dust particles in the air 8 and, through their electrostatic interaction, promote a cluster formation of dust particles. Such enlarged dust particle clusters can then be better filtered out in an air treatment device 3, 7 arranged downstream of the ionizer 4, than for example individual particles. Because of this, both a degree of separation and also a cleaning performance of the ventilation device 1 can be increased.

Besides the dust-binding effect, the ozone created during the ionization of the air 8 can also be utilised for neutralising odour-forming molecules since the highly reactive ozone decomposes and thereby neutralises such odour molecules. In addition, ozone also has an antibacterial, fungicidal and antiviral effect, as a result of which the air inside a passenger compartment of the motor vehicle 2 can be likewise improved. Here, the electrode 5 and the counter-electrode(s) 6 are electrically conductively connected to a control unit 9, by way of which a high voltage is applied to the electrode 5 or the counter-electrode(s) 6.

Here, the counter-electrode 6 can be a simple electrically conductive part of the first air treatment device 3 and/or of the second air treatment device 7, for example even a housing part of the same. Here, the ventilation device 1 according to the invention can also be parts of an air-conditioning system 10 of a motor vehicle 2. With the ventilation device 1 according to the invention, in particular a reduction of the installation space and a reduction of the costs because of a reduced cabling expenditure and also an increase of the efficiency can be achieved.

1. A ventilation device, comprising:
a first air treatment device;
an ionizer including an electrode; and
wherein a counter-electrode of the ionizer is electrically conductively connected to the first air treatment device.

2. The ventilation device according to claim 1, wherein the first air treatment device is configured as at least one of a filter device an evaporator, a heat exchanger, a PTC heating element, and a fan.

3. The ventilation device according to claim 1, further comprising a second air treatment device, wherein the counter-electrode of the ionizer is connected to the second air treatment device in an electrically conductive manner.

4. The ventilation device according to claim 3, wherein the second air treatment device is a filter device.

5. The ventilation device according to claim 3, wherein the second air treatment device is an evaporator.

6. The ventilation device according to claim 3, wherein the second air treatment device is a heat exchanger.

7. The ventilation device according to claim 3, wherein the second air treatment device is a PTC heating element.

8. The ventilation device according to claim 3, wherein the second air treatment device is a fan.

9. The ventilation device according to claim 3, wherein the ionizer is arranged one of:
downstream of the first air treatment device and upstream of the second air treatment device; and
upstream of the first air treatment device and downstream of the second air treatment device.

10. An air-conditioning system of a motor vehicle, comprising the ventilation device according to claim 1.

11. The ventilation device according to claim 1, wherein a component of the first air treatment device defines the counter-electrode of the ionizer.

12. The ventilation device according to claim 11, wherein the component is a housing of the first air treatment device.

13. The ventilation device according to claim 1, further comprising a controller via which a voltage is appliable to at least one of the electrode and the counter-electrode, wherein the controller is electrically conductively connected to the at least one of the electrode and the counter-electrode.

14. The ventilation device according to claim 1, wherein the first air treatment device is an electrically conductive activated charcoal filter.

15. The ventilation device according to claim 4, wherein the filter device is an electrically conductive activated charcoal filter.

16. A ventilation device, comprising:
an ionizer including an electrode;
a first air treatment device including a first component; and
a second air treatment device including a second component;
wherein the first component forms a first counter-electrode of the ionizer; and
wherein the second component forms a second counter-electrode of the ionizer.

17. The ventilation device according to claim 16, wherein:
the first component is a first housing of the first air treatment device; and
the first component is a second housing of the second air treatment device.

18. The ventilation device according to claim 16, further comprising a controller via which a voltage is appliable to at least one of the electrode, the first counter-electrode, and the second counter-electrode, wherein the controller is electrically conductively connected to the electrode, the first counter-electrode, and the second counter-electrode.

19. The ventilation device according to claim 16, wherein the ionizer is arranged downstream of the first air treatment device and upstream of the second air treatment device such that an electromagnetic field is providable in two directions.

20. The ventilation device according to claim 16, wherein the ionizer is arranged upstream of the first air treatment device and downstream of the second air treatment device such that an electromagnetic field is providable in (i) a first direction extending from the ionizer toward the first air treatment device and (ii) a second direction extending from the ionizer toward the second air treatment device.
